(19) United States
(12) Patent Application Publication
(10) Pub. No.: US 2012/0331145 A1
(43) Pub. Date: Dec. 27, 2012

(54) METHOD FOR PROVIDING AND ACCESSING RESOURCE REMOTELY

(76) Inventor: Gil-Hoon Chang, Seoul (KR)

(21) Appl. No.: 13/166,238

(22) Filed: Jun. 22, 2011

(51) Int. Cl. G06F 15/16

(52) U.S. Cl. 709/226

(57) ABSTRACT

A remote resource provision method of a remote resource provision apparatus is disclosed. The remote resource provision apparatus receives software environment information from the remote resource access apparatus, generates sub-software executed by the remote resource access apparatus from main software according to the software environment information, and transmits the generated sub-software to the remote resource access apparatus, receives a first result generated using the sub-software from the remote resource access apparatus, generates a second result from the received first result using the main software, and transmits the generated second result to the remote resource access apparatus. Accordingly, several remote resource access apparatuses can share resources of the remote resource provision apparatus.

### BACKGROUND

1. Field

The present disclosure relates to a remote resource provision method and a remote resource access method, more particularly, to a remote resource provision method and a remote resource access method, which enable one remote resource provision apparatus to execute, use and store data or programs used by a remote resource access apparatus.

2. Description of the Related Art

A personal digital assistant (PDA) is a handheld lightweight computer using a touchscreen as a main input device. The PDA has basic functions as a personal scheduler, an address book, or a calculator. While the PDA was mainly used as a personal scheduler in the past, currently, the PDA has been gradually evolved into an apparatus for utilizing multimedia.

Electronic apparatuses such as PDAs, electronic dictionaries, navigation systems and cellular phones include the functions of other electronic apparatuses in addition to basic functions. Thus, the functions of the electronic apparatuses overlap each other. However, in the electronic apparatuses such as PDAs, electronic dictionaries, navigation systems and cellular phones, although an electronic apparatus has a more excellent function, another electronic apparatus cannot share the more excellent function. Recently, although the functions of the electronic apparatuses have been gradually combined, different apparatuses cannot still share its functions with each other.

### SUMMARY

The present disclosure is directed to providing a remote resource provision method which enables one remote resource provision apparatus to execute, use and store data or programs used by a remote resource access apparatus.

The present disclosure is directed to providing a remote resource access method which enables one remote resource provision apparatus to execute, use and store data or programs used by a remote resource access apparatus.

The present disclosure is directed to providing a remote resource sharing method which enables one remote resource provision apparatus to drive, use and store data or programs used by a remote resource access apparatus.

The present disclosure is directed to providing a computer-readable recording medium having recorded thereon a program for executing the method on a computer.

In one aspect, there is provided a remote resource provision method including: receiving software environment information of a remote resource access device from the remote resource access apparatus; generating sub-software executed by the remote resource access apparatus from main software according to the software environment information; transmitting the generated sub-software to the remote resource access apparatus; receiving a first result generated using the sub-software from the remote resource access apparatus; generating a second result from the received first result using the main software; and transmitting the generated second result to the remote resource access apparatus.

The sub-software may be reconfigured by selecting a part of functions performed by the main software.

The software environment information may include at least one of resource information provided to execute the sub-software by the remote resource access apparatus, supportable software-associated information or a main software list selected by a user.

The remote resource provision method may further include generating a plurality of sessions so as to communicate with a plurality of remote resource access apparatuses.

The same second result may be transmitted to a plurality of remote resource access apparatuses by generating a single session so as to communicate with a plurality of remote resource access apparatuses.

In another aspect, there is provided a remote resource access method including: transmitting software environment information of a remote resource access apparatus to a remote resource provision apparatus; receiving sub-software generated from main software by using the software environment information by the remote resource provision apparatus from the remote resource provision apparatus; executing the received sub-software and generating a first result; and transmitting the generated first result to the remote resource provision apparatus.

The sub-software may be reconfigured by selecting a part of functions performed by the main software.

The software environment information may include at least one of resource information provided to execute the sub-software by the remote resource access apparatus, supportable software-associated information or a main software list selected by a user.

In another aspect, there is provided a remote resource sharing method including: a remote resource provision apparatus receiving software environment information of a remote resource access apparatus from the remote resource access apparatus; the remote resource provision apparatus generating sub-software executed by the remote resource access apparatus from main software according to the software environment information; the remote resource provision apparatus transmitting the generated sub-software to the remote resource access apparatus; the remote resource access apparatus executing the sub-software and generating a first result; the remote resource provision apparatus receiving the first result generated using the sub-software from the remote resource access apparatus; the remote resource provision apparatus generating a second result from the received first result using the main software; and the remote resource provision apparatus transmitting the generated second result to the remote resource access apparatus.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a flowchart illustrating a method for providing remote resources to a remote resource access apparatus at a remote resource provision apparatus according to an embodiment;

FIG. 2 is a flowchart illustrating a remote resource access method of a remote resource access apparatus for utilizing remote resources of a remote resource provision apparatus according to an embodiment;

FIG. 3 is a conceptual diagram showing a system including a remote resource provision apparatus and a plurality of remote resource access apparatuses according to an embodiment; and

FIG. 4 is a conceptual diagram showing a remote resource sharing system according to an embodiment.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

A remote resource provision method according to an embodiment includes: receiving software environment information of a remote resource access device from the remote resource access apparatus; generating sub-software executed by the remote resource access apparatus from main software according to the software environment information; transmitting the generated sub-software to the remote resource access apparatus; receiving a first result generated using the sub-software from the remote resource access apparatus; generating a second result from the received first result using the main software; and transmitting the generated second result to the remote resource access apparatus.

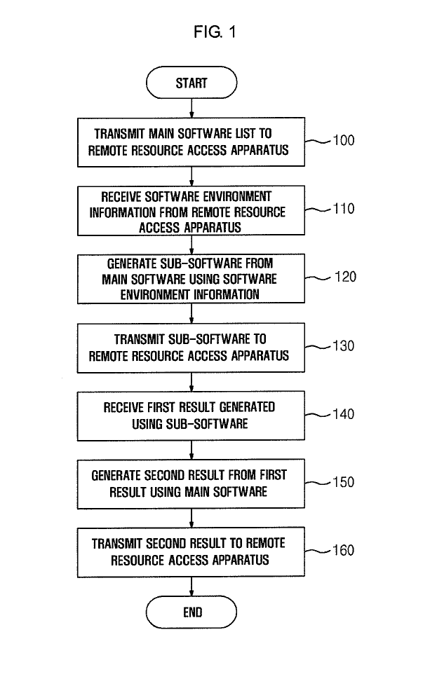

FIG. 1 is a flowchart illustrating a method for providing remote resources to a remote resource access apparatus at a remote resource provision apparatus according to an embodiment.

In step 100, the remote resource provision apparatus transmits a main software list in the remote resource provision apparatus, which may be used through sub-software, to the remote resource access apparatus. This step is performed in order to enable the remote resource access apparatus to select main software to be used, because main software used through sub-software in the remote resource access apparatus may differ according to sub-software or remote resource access apparatus. The main software list refers to a software list executed in the remote resource provision apparatus.

In step 110, the remote resource provision apparatus receives software environment information of the remote resource access apparatus from the remote resource access apparatus. The software environment information includes resource information which may be provided in order to enable the remote resource access apparatus to execute software, such as an input/output port number, a screen size, a resolution and a memory size, software functional information supported by the remote resource access apparatus, and software-associated information such as software version. The software environment information may further include a main software selection list to be used by a user through the remote resource access apparatus. The main software selection list included in the software environment information may be used to generate sub-software. If main software which is uniquely used in the remote resource access apparatus is present, since the main software selection list is fixed, the main software selection list corresponding to the remote resource access apparatus may be previously stored and used or may be registered in the remote resource provision apparatus by a user, without receiving the main software selection list from the remote resource access apparatus.

The remote resource provision apparatus generates sub-software using the software environment information and provides the sub-software to the remote resource access apparatus. The sub-software may be software obtained by reconfiguring a part of main software executed in the remote resource provision apparatus to suit resources supported by the remote resource access apparatus, such as a screen size, a resolution and a memory size, or software interfacing with a user. The software interfacing with the user may be generated in the form of a window and may be provided to the remote resource access apparatus.

In step 120, the remote resource provision apparatus generates sub-software, which may be executed by the remote resource access apparatus, from the main software according to the received software environment information. The sub-software generated from the main software may be used to receive information necessary to execute the main software from the user or to receive the result of executing the main software and provide the result to the user. A function which is determined to be more suitably executed in the remote resource access apparatus among the functions of the main software may be included as sub-software, according to user selection. Accordingly, the sub-software may include only functions selected by the user from among the functions of the main software.

The sub-software suitable for the remote resource access apparatus may be previously stored in the remote resource provision apparatus. Software for implementing the remote resource provision method according to the embodiment may be stored in a storage medium and this storage medium may be connected to a predetermined computing device (a PC, a PDA, an electronic dictionary, a cellular phone, a laptop computer, etc.), thereby allowing the predetermined computing device to have the functions of the remote resource provision apparatus. The storage medium may have a function for communicating with peripheral remote resource access apparatuses.

In step 130, the remote resource provision apparatus transmits the sub-software to the remote resource access apparatus. The remote resource provision apparatus and the remote resource access apparatus may communicate with each other over a local area network (LAN) such as Bluetooth or Zigbee.

In step 140, the remote resource provision apparatus receives a result generated by the remote resource access apparatus using the transmitted sub-software. The result generated using the sub-software may be a value received from the user or a value obtained by processing the value received from the user.

In step 150, the remote resource provision apparatus generates a new result from the result received in step 140 using the main software. The main software may require resources more than that of the sub-software or may have a function which cannot be supported by the remote resource access apparatus.

In step 160, the remote resource provision apparatus transmits the result generated in step 150 to the remote resource access apparatus.

Thereafter, the remote resource provision apparatus determines whether the execution of the main software is finished. If it is determined that the execution of the main software is not finished, the method progresses to step 140. In contrast, if it is determined that the execution of the main software is finished, the method is finished.

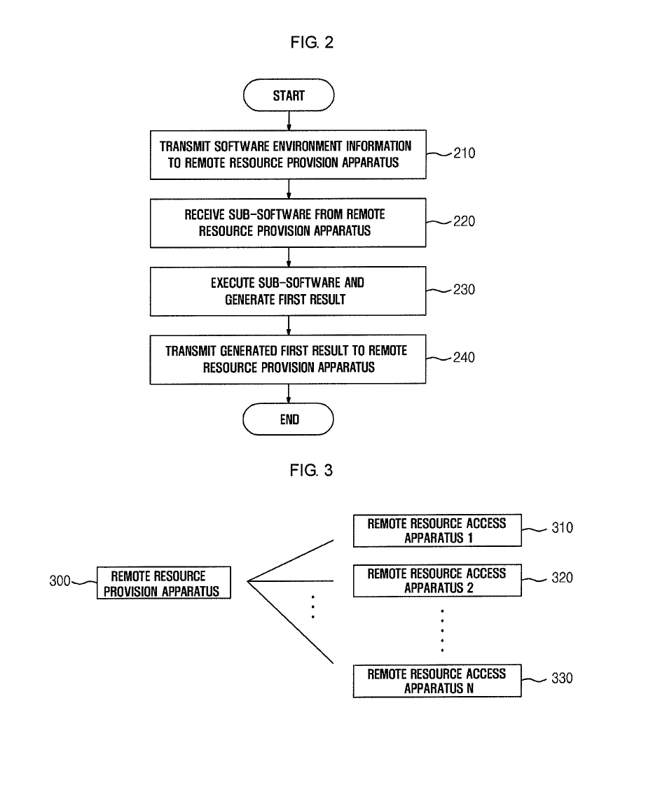

FIG. 2 is a flowchart illustrating a remote resource access method of a remote resource access apparatus for utilizing remote resources of a remote resource provision apparatus according to an embodiment.

In step 210, the remote resource access apparatus transmits software environment information to the remote resource provision apparatus. The software environment information includes resource information which may be provided in order to enable the remote resource access apparatus to execute software, such as an input/output port number, a screen size, a resolution and a memory size, software functional information supported by the remote resource access apparatus, and software-associated information such as software version.

In step 220, the remote resource access apparatus receives sub-software from the remote resource provision apparatus. The remote resource provision apparatus generates the sub-software using the software environment information and transmits the sub-software to the remote resource access apparatus. The sub-software may be software obtained by reconfiguring a part of main software executed in the remote resource provision apparatus to suit resources supported by the remote resource access apparatus, such as a screen size, a resolution and a memory size, or software interfacing with a user. The software interfacing with the user may be generated in the form of a window and may be provided to the remote resource access apparatus.

In step 230, the remote resource access apparatus executes the sub-software and generates a result. The remote resource access apparatus may use a value received from a user as an input value of the sub-software.

In step 240, the remote resource access apparatus transmits the result generated in step 230 to the remote resource provision apparatus.

The result transmitted to the remote resource provision apparatus in step 240 may be input to the main software again and may be used to generate a new result. The new result generated by the main software is transmitted to the remote resource access apparatus again and is provided to the user.

FIG. 3 is a conceptual diagram showing a system including a remote resource provision apparatus and a plurality of remote resource access apparatuses according to an embodiment.

Referring to FIG. 3, the remote resource sharing system according to the embodiment includes the remote resource provision apparatus and the plurality of remote resource access apparatuses.

The remote resource provision apparatus 300 executes software which cannot be executed by the remote resource access apparatuses 310, 320 and 330 and transmits results to the remote resource access apparatuses 310, 320 and 330. The remote resource provision apparatus 300 according to the embodiment receives software environment information of the remote resource access apparatuses 310, 320 and 330 and transmits sub-software suitable for the software environment information of the remote resource access apparatuses 310, 320 and 330 to the remote resource access apparatuses 310, 320 and 330. Since the remote resource access apparatuses 310, 320 and 330 can transmit different sub-software, the plurality of remote resource access apparatus may share the resources of one remote resource provision apparatus 300.

The remote resource access apparatuses 310, 320 and 330 and the remote resource provision apparatus 300 exchange the software environment information with each other. For example, the software environment information may be transmitted to the remote resource provision apparatus 300 in order to receive application software supported by the remote resource access apparatuses 310, 320 and 330 from the remote resource provision apparatus 300. The software environment information includes resource information which may be provided in order to enable the remote resource access apparatus to execute software, such as an input/output port number, a screen size, a resolution and a memory size, software functional information supported by the remote resource access apparatus, and software-associated information such as software version.

The remote resource provision apparatus 300 may communicate with the peripheral remote resource access apparatuses 310, 320 and 330 with multiple sessions. Multiple sessions refer to multi-access activated between the remote resource provision apparatus 300 and the remote resource access apparatuses 310, 320 and 330. Accordingly, the remote resource provision apparatus 300 generates several sessions such that several remote resource access apparatuses are simultaneously supported.

In addition, the remote resource provision apparatus 300 may communicate with the peripheral remote resource access apparatuses 310, 320 and 330 with a single session. If communication is performed using a single session, the remote resource provision apparatus 300 may transmit the same assistive program to the peripheral remote resource access apparatuses 310, 320 and 330, and a plurality of users may share the same screen using the remote resource access apparatuses 310, 320 and 330.

The remote resource provision apparatus 300 provides a function for selecting whether the screen for operating the assistive programs in the remote resource access apparatuses 310, 320 and 330 is displayed to a user.

For example, the remote resource provision apparatus 300 may be a personal computer (PC) having a wireless LAN function, and the remote resource access apparatuses 310, 320 and 330 may be portable input/output devices having a wireless LAN function. At this time, application programs which are easily executed by the portable input/output apparatuses may be selected from general application programs stored in the PC and may be reconfigured so as to be sent to the portable input/output apparatuses.

A portable input/output apparatus may be an apparatus having a screen and a keyboard, such as a laptop computer, or an apparatus having a small screen and a pen input function, such as a personal digital assistant (PDA). When the application programs of the PC are reconfigured and delivered to a user who uses an input/output apparatus, the user share hardware/software resources of the PC while using the laptop computer or the PDA. Resources refer to components available in a computer, such as a device connected to a computer system, an internal system of a computer, a file, network connection, and a memory region.

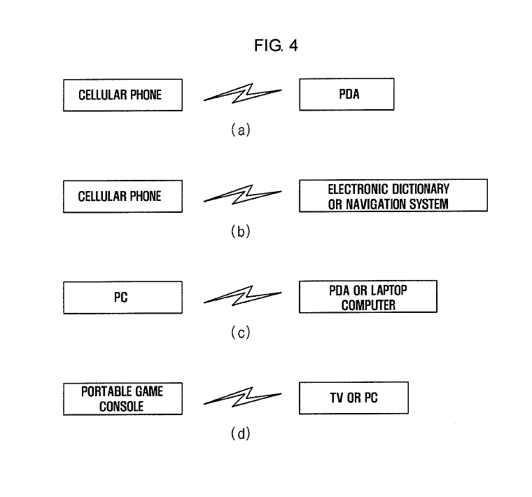

FIG. 4 is a conceptual diagram showing a remote resource sharing system according to an embodiment.

FIG. 4(a) shows the case where a remote resource provision apparatus is a cellular phone and a remote resource access apparatus is a PDA.

A user can view content of the cellular phone using the PDA and can use remotely a function of the cellular phone which cannot be performed by the PDA. That is, if the PDA does not have a communication function or if the PDA has a communication function (Bluetooth, UWB, WiFi, WiMAX, etc.) but cannot use a network service, the cellular phone is used as the remote resource provision apparatus having a data service and Internet access function. The user receives content suitable for the input/output function of the PDA or content suitable for both the input/output functions of the cellular phone and the PDA using the data service and Internet access function of the cellular phone and uses the content in the PDA.

FIG. 4(b) shows the case where a remote resource provision apparatus is a cellular phone and a remote resource access apparatus is an electronic dictionary or a navigation system.

The remote resource access apparatus may be a dedicated apparatus having only a specific function, such as an electronic dictionary or a navigation system, and may use all or a part of the functions of the cellular phone similarly to FIG. 4(a).

Conversely, the remote resource provision apparatus may be an electronic dictionary or a navigation system and the remote resource access apparatus may be a cellular phone. The cellular phone provides the function of the electronic dictionary or the navigation system to a user. In some circumstances, such as when a user walks, the user may more easily perform an input/output function of the cellular phone with one hand as compared to the electronic dictionary or the navigation system.

FIG. 4(c) shows the case where a remote resource provision apparatus is a PC and a remote resource access apparatus is a PDA or a laptop computer.

The remote resource access apparatus may be an apparatus which is easier to carry around than a PC, such as a PDA or a laptop computer. A computer having excellent program processing power and supporting multiple sessions (multiple input/output apparatus connections) is used as the remote resource provision apparatus and a portable apparatus having a dedicated input/output function, such as a PDA or a laptop computer, is used as the remote resource access apparatus. Portability and free positioning of the remote resource access apparatus are ensured within a field where both the apparatuses can be connected to each other. Multiple input/output device connections provide several input/output functions to one computer such that different input/output apparatus share the resources of the computer.

FIG. 4(d) shows the case where a remote resource provision apparatus is a portable game console and a remote resource access apparatus is a TV or a PC.

If a user does not move, the user may play a game of the portable game console using the TV or PC having a good input/output function.

In addition, if the remote resource provision apparatus and the remote resource access apparatus communicate with each other according to one embodiment, when a presentation is given at a conference room or at a place other than the conference room, a beam projector may simply share a file of the remote resource provision apparatus. Family members may utilize one remote resource provision apparatus through their remote resource access apparatuses so as to share the resources of one remote resource provision apparatus.

The above-described embodiments may be written by a program executed on a computer and may be implemented on a general-purpose digital computer for operating the program using a computer-readable recording medium. The structure of data used in the above-described embodiments may be recorded on a computer-readable recording medium using various units.

The computer-readable recording medium includes a magnetic storage medium (e.g., a ROM, a floppy disk, a hard disk, etc.), an optical reading medium (e.g., a CD-ROM, a DVD, etc.) and a storage medium such as carrier waves (e.g., data transmission through the Internet).

According to embodiments, several remote resource access apparatus are provided within the coverage of one remote resource provision apparatus and all data or programs may be executed, used and stored in one remote resource provision apparatus. In this case, it is possible to more conveniently manage the several remote resource access apparatus. According to embodiments, if multi-communication between the remote resource provision apparatus and the several resource access apparatuses is possible, one remote resource provision apparatus may function as multiple input/output apparatus by generating multiple sessions.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A remote resource provision method comprising:
receiving software environment information of a remote resource access apparatus from the remote resource access apparatus;
generating sub-software executed by the remote resource access apparatus from main software according to the software environment information;
transmitting the generated sub-software to the remote resource access apparatus;
receiving a first result generated using the sub-software from the remote resource access apparatus;
generating a second result from the received first result using the main software; and
transmitting the generated second result to the remote resource access apparatus.

2. The remote resource provision method according to claim 1, wherein the sub-software is reconfigured by selecting a part of functions performed by the main software.

3. The remote resource provision method according to claim 1, wherein the software environment information includes at least one of resource information provided to execute the sub-software by the remote resource access apparatus, supportable software-associated information, or a main software list selected by a user.

4. The remote resource provision method according to claim 1, further comprising generating a plurality of sessions so as to communicate with a plurality of remote resource access apparatuses.

5. The remote resource provision method according to claim 1, wherein the same second result is transmitted to a plurality of remote resource access apparatuses by generating a single session so as to communicate with a plurality of remote resource access apparatuses.

6. A remote resource access method comprising:
transmitting software environment information of a remote resource access apparatus to a remote resource provision apparatus;
receiving sub-software generated from main software by using the software environment information by the remote resource provision apparatus from the remote resource provision apparatus;
executing the received sub-software and generating a first result; and
transmitting the generated first result to the remote resource provision apparatus.

7. The remote resource access method according to claim 6, wherein the sub-software is reconfigured by selecting a part of functions performed by the main software.

8. The remote resource access method according to claim 6, wherein the software environment information includes at least one of resource information provided to execute the sub-software by the remote resource access apparatus, supportable software-associated information or a main software list selected by a user.

9. A remote resource sharing method comprising:
a remote resource provision apparatus receiving software environment information of a remote resource access apparatus from the remote resource access apparatus;
the remote resource provision apparatus generating sub-software executed by the remote resource access apparatus from main software according to the software environment information;
the remote resource provision apparatus transmitting the generated sub-software to the remote resource access apparatus;
the remote resource access apparatus executing the sub-software and generating a first result;
the remote resource provision apparatus receiving the first result generated using the sub-software from the remote resource access apparatus;
the remote resource provision apparatus generating a second result from the received first result using the main software; and
the remote resource provision apparatus transmitting the generated second result to the remote resource access apparatus.

10. A computer-readable recording medium having recorded thereon a program for executing the method according to claim 1.

11. A computer-readable recording medium having recorded thereon a program for executing the method according to claim 2.

12. A computer-readable recording medium having recorded thereon a program for executing the method according to claim 3.

13. A computer-readable recording medium having recorded thereon a program for executing the method according to claim 4.

14. A computer-readable recording medium having recorded thereon a program for executing the method according to claim 5.

15. A computer-readable recording medium having recorded thereon a program for executing the method according to claim 6.

16. A computer-readable recording medium having recorded thereon a program for executing the method according to claim 7.

17. A computer-readable recording medium having recorded thereon a program for executing the method according to claim 8.

18. A computer-readable recording medium having recorded thereon a program for executing the method according to claim 9.
